(19) United States
(12) Patent Application Publication
(10) Pub. No.: US 2014/0007568 A1
(43) Pub. Date: Jan. 9, 2014

(54) POWER CAPTURE OF WAVE ENERGY CONVERTERS

(71) Applicant: Michael David Crowley, Frampton on Seven (GB)

(72) Inventor: Michael David Crowley, Frampton on Seven (GB)

(21) Appl. No.: 14/005,711

(22) PCT Filed: Mar. 22, 2012
(86) PCT No.: PCT/GB12/50624

§ 371 Date: Sep. 17, 2013

(30) Foreign Application Priority Data
Mar. 23, 2011 (GB) 1104843.6

(51) Int. Cl. F03B 13/16; F03B 11/00

(52) U.S. Cl. CPC F03B 13/16; F03B 11/00
USPC 60/497

(57) ABSTRACT

A wave power capture system includes a double acting piston arrangement in which reciprocation of the piston arrangement as a result of wave action to causes hydraulic fluid to be pumped into a hydraulic supply to a hydraulic motor and the flow and differential pressure of the double acting piston may be different to the flow and differential pressure provided to the hydraulic supply and that such difference is variable. Various ways in which this is achieved are described including: a duct access to which is controlled by a valve connected between the outputs of the reciprocation double acting piston arrangement; a double headed piston in a cylinder with one end of the cylinder hydraulically connected to one output of the reciprocating double acting piston arrangement and the other end the cylinder to the other output of the double acting piston arrangement: one or more pairs of piston operated pressure intensifiers, the low pressure side of one of each of the pairs of pressure intensifiers being connected hydraulically to one output the double acting piston arrangement and the low pressure side of the other of each of said pairs connected hydraulically to the other output of the double acting piston arrangement, and the high pressure side of each pair of pressure intensifiers being connected through one way check valves to the hydraulic supply of said hydraulic motor and wherein the rods of the pairs of intensifiers are connected together to that they drive one another and wherein one charges from its low pressure input and supplies a higher pressure output, while the other returns an uncharged position; or a combination of the above. Alternatively a variable hydraulic intensifier may be employed.

Wave energy converters convert sea wave power into other forms of useful power (usually electrical power). In recent years there has been an increased interest in generation of power from renewable sources including wave power because of the global warming effects of increase carbon dioxide levels associated with conventional power generation.

Many wave energy converters devices use hydraulics to convert the wave motion into rotary motion which can then be used to drive an electric generator. Wave power devices provide a relative motion between two structural elements. One example one is the sea bed or something anchored to it with a float moving with the waves (for example Aquamarine Power's Oyster™ device). Another example is a device coupled to different parts of the wave (such as the device made by Pelamis Wave Power). This relative motion can then be used to force a hydraulic cylinder in and out so producing hydraulic power.

Hydraulic power take-off is the preferred power take-off method for many wave devices, as hydraulics work well with the high loads and low oscillating frequencies that occur in wave power devices. It is this hydraulic power conversion system that this current invention is aimed to improve.

Use of relative motion produced by waves to drive a reciprocating double headed piston in a cylinder to produce hydraulic power is known for example from GB2467011A and GB2472093A

The instantaneous hydraulic power generated by the systems of these known types employing a reciprocating piston to generate hydraulic power is the product of flow rate and pressure. The hydraulic output of the cylinder is applied to the feed line of high pressure side of a hydraulic motor and generator combination usually designed so that it is possible to control the pressure in the feed line by controlling the flow through the motor. The resistive load applied to the reciprocating piston is the product of pressure and cylinder area. The pumped flow rate is the product of cylinder area and cylinder velocity.

If the operating pressure is zero then the cylinder will apply little or no resistive load, so the cylinder will have maximum displacement and its velocity and pumped flow will be at a maximum. But as the pressure is zero the power generated will also be zero. Conversely if the pressure is too high as a result of back pressure from the feed to the hydraulic motor, the force required to move the cylinder will be greater than the load the wave device can provide, the cylinder will not pump fluid, and no hydraulic power will be generated.

According to the present invention, a wave power capture system is characterised in comprising a double acting piston arrangement coupled to and driven from a reciprocating source of wave energy, each output of the double acting piston arrangement being connected to a common a hydraulic supply to a hydraulic motor wherein reciprocation of the source of wave energy pumps hydraulic fluid alternately from each output of the double acting piston arrangement and wherein the flow from and differential pressure of the double acting piston arrangement may be different to the flow and differential pressure provided to the hydraulic supply and that such difference is variable.

In such a wave power capture system hydraulic fluid may be supplied to the hydraulic supply at a reduced rate until the output flow rate of the double acting piston arrangement exceeds a predetermined minimum.

In this specification the expression double acting piston arrangement means a piston pumping device or devices which receives input power from the sea wave motion and which will pump output when waves are moving in either direction.

Examples of such double acting piston arrangements include:
a single double headed piston operating in a single cylinder wherein power extracted from a wave that is moving in one direction will move the piston in one direction within the cylinder, and power extracted from a wave is moving in another direction will move the piston in the opposite direction, and the cylinder can pump from both sides of the piston head responsive to piston movement in either direction;
a pair of conventional displacement cylinders acting co-operatively where in power from a wave motion in one direction is fed to the piston of a first cylinder causing that cylinder to execute a compression stroke to pump hydraulic fluid in the cylinder, at the same time the second cylinder expands drawing hydraulic fluid from a supply into the cylinder, when wave movement in the opposite direction the second cylinder undergoes a compression stroke and pumps the hydraulic fluid drawn in and the first cylinder expands drawing in further hydraulic fluid form the supply.

In an arrangement involving a pair of displacement cylinders, the coupling can be mechanical including the possible use of two displacement cylinders with a common rod, or directly coupled rods.

In one arrangement such a wave power capture system the outputs sides of the

double acting piston arrangements have a direct hydraulic connection by-passing the hydraulic motor, access to the direct hydraulic connection being controlled by a stop valve which is open until the output flow rate of the double acting piston arrangement exceeds the predetermined minimum.

In another arrangement such wave power capture system has a double headed piston in a cylinder with one end of the cylinder to one side of the double headed piston hydraulically connected to one output of the reciprocating double acting piston arrangement and the other end the cylinder to the other side of the double headed piston hydraulically connected to the other output of the reciprocating double acting piston.

Such a wave power capture system as described in the preceding paragraphs may comprise a first pair hydraulic intensifiers, the low pressure side of the pairs of hydraulic intensifiers being connected hydraulically to one output of the double acting piston arrangement and the low pressure side of the other of said pair connected hydraulically to the other output of the double acting piston arrangement and the high pressure side of each hydraulic intensifier is connected via non-return valves to the hydraulic supply to the hydraulic motor.

A hydraulic intensifier is a device which is used to increase the intensity of pressure of any hydraulic fluid or water, with the help of the hydraulic energy available from a huge quantity of water or hydraulic fluid at a low pressure. A number of such devices are known.

Preferably the hydraulic intensifiers comprise piston operated hydraulic intensifiers wherein the pairs of intensifiers are connected together to that they drive one another, wherein one charges from its low pressure input and supplies an output at higher pressure while the other returns to an uncharged position or vice versa. Usually this is achieved by having a common rod connecting the pistons of each intensifier.

Further intensifiers may be connected to the double acting piston arrangement in a similar way to the first pair of hydraulic intensifiers. In such a case the sides of the pairs of hydraulic intensifiers are arranged such that their pressure intensification decreases in steps from one pair whose intensification is relatively high when compared with a final pair (or put another way the cylinder volumes increase from the intensifiers having the greatest intensification to the intensifiers having the lowest pressure intensification).

Such intensifiers may respond in turn to increasing flow rates from the double acting piston arrangement.

This can be achieved by regulating entry to each pair of intensifiers with valves which open and close on the basis of the output flow rate from the double acting piston arrangement.

A variable intensifier can be used with this invention instead of the piston operated intensifiers described in the preceding paragraphs. In this case a hydraulic motor is driven from a pumped hydraulic supply whose flow direction may change. The motor drives a variable displacement over centre pump which can pump in in one direction only even when the hydraulic motor changes direction was a result of reversal of flow through it. Applied to the present invention the hydraulic motor of the intensifier is placed in a duct between the outputs of the double acting piston arrangement. Hydraulic fluid passes between the outlets of the double acting piston arrangement, the direction of flow depending on the input wave motion from the sea into the double acting piston arrangement. The hydraulic motor will drive the over centre pump, which will draw hydraulic fluid from a supply and pump it to the supply line of the main hydraulic motor of the system. When the variable over centre pump has zero displacement the cylinder load on the double acting piston arrangement will be minimum. As the variable displacement of the pump increases so will the cylinder load on the double acting piston arrangement.

Often the double acting piston arrangement comprises a double headed piston head reciprocating in a single cylinder. Alternatively mechanically linked displacement cylinders can be used.

Normally double headed pistons have a rod on one side of the piston head, although through rodded double headed pistons can be used with advantage. The power capture system of this invention may compensate for differences in the chamber area either side of the double acting piston.

In one particular arrangement a wave power capture system comprises:
one or more double headed first piston heads each reciprocating in their own cylinders;
a double headed piston in a cylinder with one end of the cylinder hydraulically connected to one output of the reciprocating double acting piston arrangement and the other end the cylinder to the other side of the double headed piston;
one or more pairs of piston operated pressure intensifiers, the low pressure side of one of each of the pairs of pressure intensifiers being connected hydraulically to one output the double acting piston arrangement and the low pressure side of the other of each of said pairs connected hydraulically to the other output of the double acting piston arrangement, with the high pressure side of each pair of pressure intensifiers being connected through one way check valves to the hydraulic supply of said hydraulic motor, wherein the rods of the pairs of intensifiers are connected together to that they drive one another and wherein as one of intensifiers charges from its low pressure input and supplies a higher pressure output, the other returns to an uncharged position;
the hydraulic capacity of each pair intensifiers increasing in steps from a first stage pair to a final stage pair; and
wherein increases in the output flow of the first double acting piston arrangement will drive in turn the further double headed piston and then each stage of the pairs of pressure intensifiers.

In a wave power capture system described in the preceding paragraph, the further double headed piston may be arranged in its cylinder such that the volumes of the cylinder either side of the double headed piston differ to compensate for differences in the volumes either side of the double headed piston.

Normally the system described in this invention is one of a number of similar systems in a wave farm supplying a single hydraulic motor though the motors hydraulic supply. It can thus be seen that the pressure in the hydraulic to the motor is independent of the output of any single double headed piston and is set, as described, according to particular sea climate or state.

The invention will be now fully described with reference to the accompanying drawings in which:

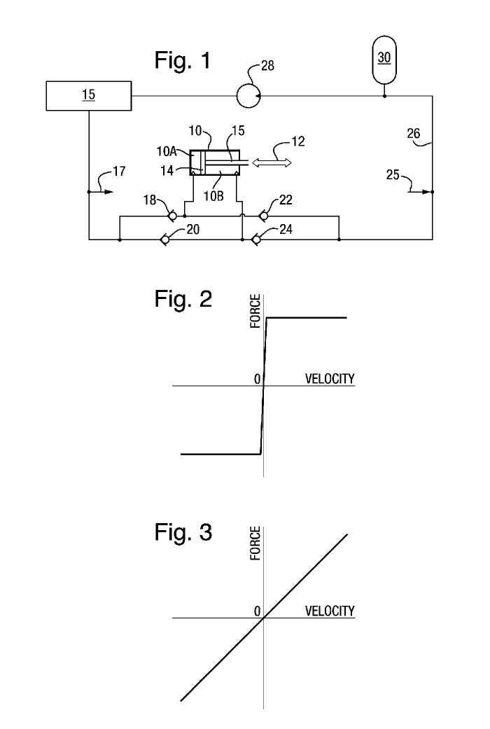

FIG. 1 is a schematic drawing showing an existing wave power capture system;

FIG. 2 shows a cylinder force velocity profile for the wave capture device of FIG. 1;

FIG. 3 shows a better and idealised desired cylinder force velocity profile;

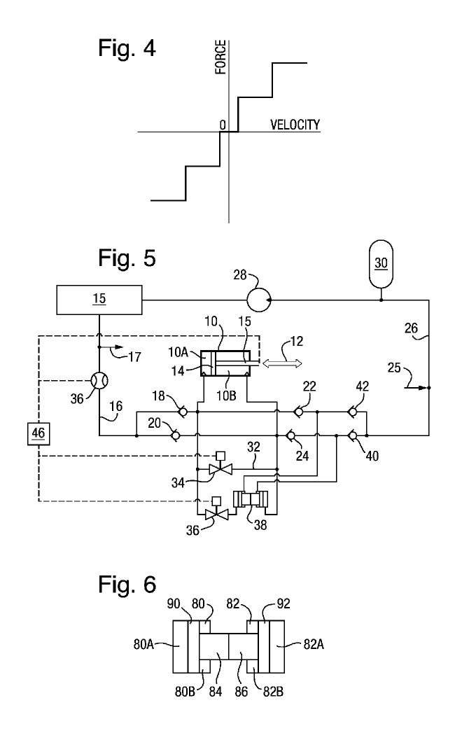

FIG. 4 shows a profile of the kind that this invention seeks to achieve;

FIG. 5 shows schematically a simple implementation of this invention with control using a computer;

FIG. 6 shows schematically a pair of intensifiers for use in this invention;

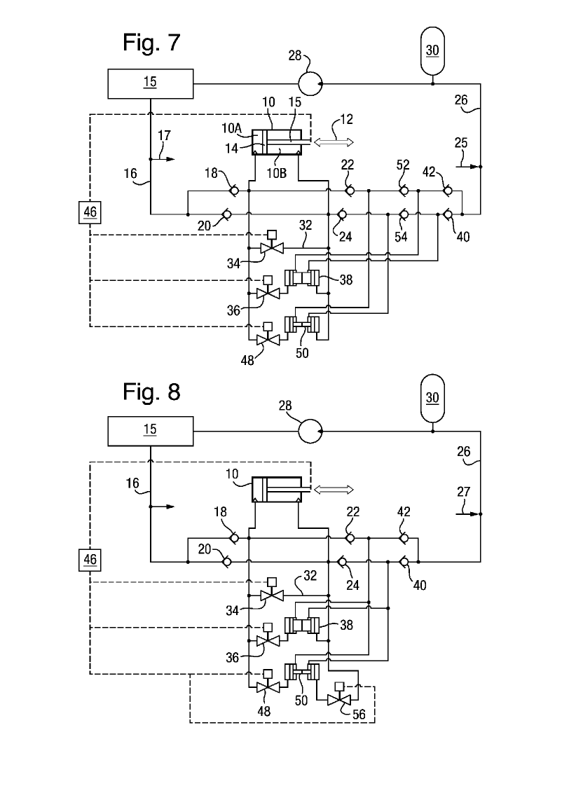

FIG. 7 shows a system similar to that in FIG. 5 but with multiple pairs of intensifiers;

FIG. 8 shows an alternative arrangement to that shown in FIG. 7;

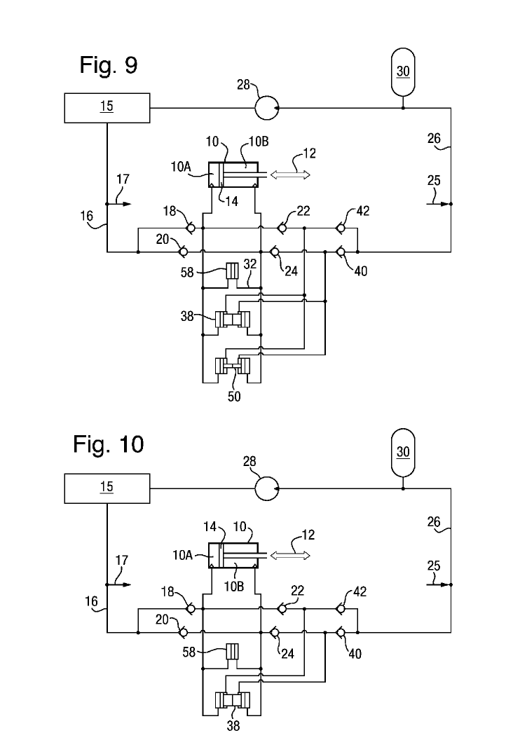

FIG. 9 shows an embodiment similar to that of FIG. 8 but avoiding the use of computer controlled valves;

FIG. 10 shows a simpler two stage system;

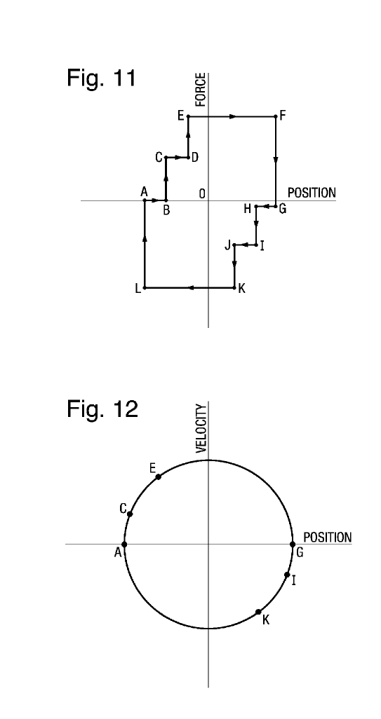

FIG. 11 shows the force vs. position profile for the reciprocating double headed cylinder shown in FIG. 10;

FIG. 12 illustrates the velocity vs. position profile for the reciprocating double headed cylinder shown in FIG. 10;

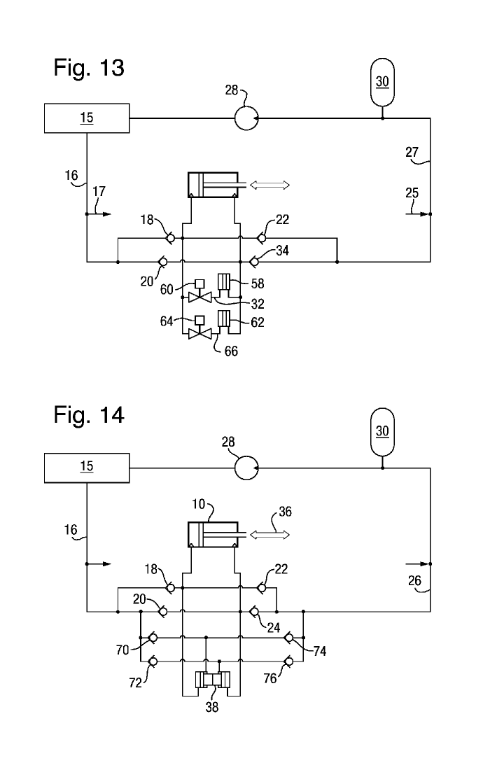

FIG. 13 shows a semiautomatic system according to the invention;

FIG. 14 shows an alternative arrangement for the intensifier stages; this arrangement may be used instead of the intensifier stages shown in FIG. 9 for example;

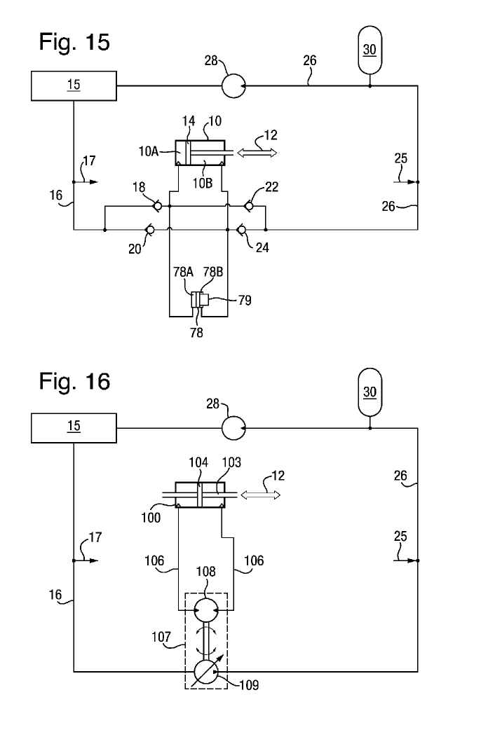

FIG. 15 shows an alternative arrangement for the first stage shown in FIGS. 9 and 10;

FIGS. 16 to 18 illustrate the use of an alternative hydraulic intensifier;

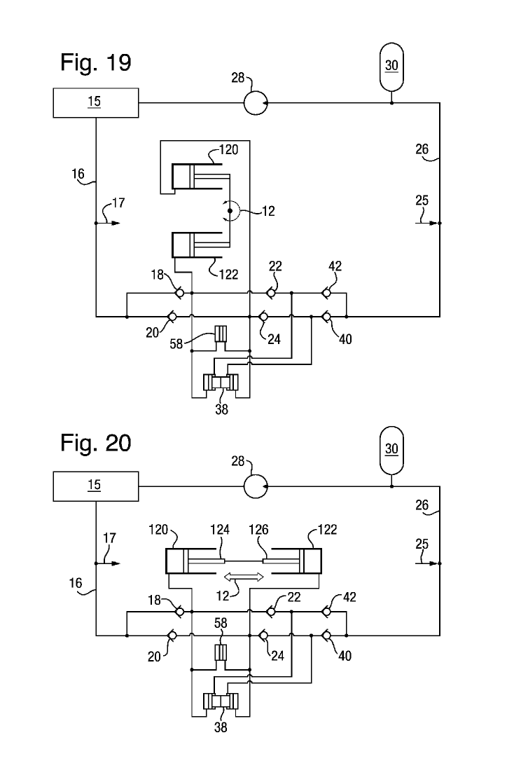

FIG. 19 shows the use of two displacement cylinders each with pistons instead of a double headed piston in a single cylinder in the arrangement shown in FIG. 10;

FIG. 20 shows the use of two displacement cylinders each with pistons linked rods instead of a double headed piston in a single cylinder in the arrangement shown in FIG. 10.

In FIG. 1, showing a simple schematic of a typical existing hydraulic power take off system, the wave energy converter (represented by the double headed arrow 12) moves double headed piston 14 in a hydraulic cylinder 10. In the figure, the right hand side 10B of the cylinder which contains the piston rod is known as the annulus. The left hand side 10A of the cylinder which has no piston rod is known as the bore. The movement of the piston 14 to the left into the full bore 10A is known as the compression stroke, and moving the piston to the right, expanding the volume of the full bore 10A, is known as the expansion stroke (even though the annulus 10B volume is compressed). This convention is used throughout this specification for all the piston systems described herein.

The amplitude, frequency, and strength of the applied forces 12 acting on the cylinder is a function of the wave climate or state and the pressure on the cylinder itself.

A low pressure tank 15 supplies low pressure hydraulic, typically water or oil through a supply line to check valves 18 and 20. On the expansion stroke, low pressure fluid is sucked through check valve 18 into the full bore 10A of the cylinder 10 at the same time high pressure fluid is pumped from the annulus 10B through check valve 24 into the high pressure supply 26 to a hydraulic motor 28. When the applied force 12 reverses, piston 14 will start to move in the opposite direction, the annulus 10B now expands in volume and hydraulic fluid is drawn in through check valve 20 and high pressure fluid is pumped out from the full bore 10A through check valve 22. So a pumping action can generally be achieved on both strokes of the piston 14 in either direction. Often there is an accumulator 30 in the high pressure circuit to smooth the power output from the device. The high pressure fluid is then used to drive the hydraulic motor 28 which in turn can be used to drive an electric generator. The cylinder 10 is one of a number in a wave farm supplying hydraulic fluid to the hydraulic motor 28, supplies from the other cylinders is shown schematically by the label 25, supplies of fluid to the other cylinders is shown schematically by the label 17.

If the operating pressure is zero then the cylinder will apply little or no resistive load, so the cylinder will have maximum displacement and its velocity and pumped flow will be at a maximum. But as the pressure is zero the power generated will also be zero. Conversely if the pressure is too high, the force required to move the piston 14 will be greater than the load the wave device can provide, so the cylinder will not pump fluid and no hydraulic power will be generated from cylinder 10.

There is an optimal pressure which will provide the optimal resistive cylinder load, so extracting the maximum amount of power from the wave device. This optimal pressure is a function of the wave climate. Generally the more powerful and bigger the waves are the higher the operating pressure should be, so usually with wave power devices the operating pressure can be tuned so that it produces the maximum power for the current wave climate.

FIG. 2 shows an idealised cylinder force velocity profile for a typical wave device. The magnitude of the force can be varied by changing the operating pressure. The negative force may have a different magnitude to the positive force. This force difference depends on the type of cylinder used. As velocity moves from negative to positive the force also changes sign. The change in force direction is not quite instantaneous because of some compressibility of the hydraulic fluid, and spring in the mechanical structure. FIG. 2 is an idealised profile because for a real system the pressure control cannot maintain a constant pressure; surge and hydraulic flow losses will worsen this pressure instability.

Real seas are made up of a number of waves of different wave periods and heights. Each of these different waves will have its own optimal cylinder loading to extract the maximum amount of power from the waves. Additionally to extract the maximum power from a single wave, the cylinder loading should increase with increasing velocity. With a cylinder loading of the type shown in FIG. 2 the wave capture device stalls at the end of its stroke, and does not start moving again until the wave force has increased sufficiently in the opposite direction.

A better profile for cylinder force vs. velocity would be that shown in FIG. 3. FIG. 3 shows a simple linear relationship between force and velocity but other profiles could be used and the maximum force would normally be limited to prevent mechanical damage.

Using a more optimal force velocity profile such as that shown in FIG. 3, the power capture will increase substantially by comparison to the force velocity profile shown in FIG. 2. This optimal force profile is better for many types of wave devices, even those that don't use hydraulics such as oscillating water columns or direct drive electrical power take-offs systems.

Using hydraulics to provide the force vs. velocity profile in FIG. 3 is difficult. This invention relates to methods to achieve an approximation to this profile and FIG. 4 shows the type of velocity force profile this invention is attempting to obtain. In this particular case there are five step levels, but there could be more or less. The maximum force level will be proportional to the hydraulic pressure and by adjusting the hydraulic pressure it is possible to scale up and down this force velocity profile to the prevailing wave climate.

The invention can be implemented with a number of levels of complexity. By adding or removing some of the features; it is possible to implement a system which provides some performance improvements but not the full potential at one end of the spectrum to a relatively expensive implementation at the other to implement. The system designer would need to carry out a cost benefit analysis to see which features to include and thus the level of implementation which will be cost effective in a particular situation.

In FIG. 5, features that are common to those shown in FIG. 1 have the same labels. In the system of FIG. 5, the output from the cylinder 10 is diverted in turn through stages land 2. Stage 1 comprises a duct 32 linking the output lines of each side of the cylinder 10. Access to duct 32 is controlled by first stage valve 34. By opening the first stage valve 34, the zero force portion of the force velocity profile shown in FIG. 4 is obtained. When the first stage valve 34 is open the annulus 10B and full bore sides 10A of cylinder 10 are hydraulically connected, so as the piston 14 moves to the right and hydraulic fluid is transferred from annulus side 10B to full bore side 10A. At this stage no fluid is transferred to duct 26, so the load on the piston 14 is at a minimum; what load there is, is due to cylinder friction and hydraulic losses causing back pressure in the cylinder as the flow is transferred from one side of the cylinder to the other.

When the piston is pushed to the left when the applied force 12 reverses, the flow is from the full bore 10A to annulus 10B. As the area of full bore side 10A is greater than that of the annulus 10B, some fluid will be pumped through valve 22 into duct 26; therefore, during the compression stroke of piston 14, there is a small increase in cylinder force.

This pumping on compression strokes could be avoided by using a through rod cylinder or using the arrangement shown in FIG. 15. However through rod cylinders are not common in wave power devices. The effective cylinder load generated by pumping on the compression stroke is further reduced by the second stage explained below.

To obtain the intermediate loads shown in FIG. 4, the first stage valve 34 is closed and the second stage valve 36 is open; it is preferable that the second stage valve 36 is also open when the first stage valve 34 is open.

The second stage valve 36 is connected to a pair of pressure intensifiers 38. FIG. 6 is a more detailed schematic view of the pair of intensifiers 38.

The pair of intensifiers is made of individual intensifiers 80 and 82, each having pistons 90 and 92 respectively operating in cylinders. The rods 84 and 86 of pistons 90 and 92 are joined end to end, so that when one cylinder is in an expansion stroke, the other is in a compression stroke.

As the main cylinder 10 undergoes an expansion stroke due to an applied wave force 12, hydraulic fluid from the annulus 10B is transferred under pressure into the full bore 82A of intensifier 82. This moves the intensifier pistons 90 and 92 to the left. This produces higher pressure fluid at the annulus 82B of the right hand intensifier 82 When the main piston 14 executes a compression stroke by moving to the left, the intensifiers 80 and 82 work in the opposite direction.

The higher pressure fluid from annulus is then pumped forward through check valve 40 into the high pressure hydraulic fluid delivery line 26 to the motor 28. Check valve 24 is closed at this stage and separates the intermediate main cylinder 10 pressure from the higher delivery pressure in line 26. The main cylinder 10 is now pumping against a reduced pressure and this provides the intermediate cylinder force shown in FIG. 4.

As the full bore 82A of intensifier 82 is extending the full bore 80A of intensifier 80 is contracting and hydraulic fluid from the full bore side 80A of the left intensifier 80 is being transferred into the full bore 10A of the main cylinder 10 and at the same time annulus 80B of the left hand intensifier 80 is refilled with low pressure fluid via check valve 22.

When the intensifiers' cylinders have the same areas as shown in FIG. 6 the pressure and flow distribution in the system can be a little more complex during the compression stoke of piston 14, as the intensifier's cylinders are transferring fluid, from the main bore 82A of intensifier 82 to the annulus 10B of the main cylinder 10. But as the volume of flow being transferred from the full bore 82A is greater than the volume that annulus 10B can accept the difference is pumped forward through check valve 24. It is probably better to use different areas on the left and right intensifiers to adjust for differences in annulus 10B and full bore areas 10A of the main cylinder 10.

The volumes of the cylinders of intensifiers 80 and 82 need to be optimised such that they have sufficient capacity for most wave climates. However when the intensifiers have insufficient volume to cope with the flow from the main cylinder 10, delivery pressure from the main cylinder 10 will then increase to the pressure in the main supply duct 26. As the stroke volume in both directions of travel will never be exactly equal it is inevitable that the intensifiers tend to drift to one side and clip off some small amount of the desired intermediate pressure control.

Ignoring losses due to friction and the small force required to move the right hand cylinder the ratio of pressures between the full bores 82A and annulus 10B of the cylinder is the inverse to area ratios between the full bore 82A and annulus 10B. By choosing appropriate area ratios it is possible to design the intensifier such that it will double the pressure at the annulus 82B. Likewise for the ratios of the full bore 80A and the full bore 10A.

When the second stage valve is closed or the intensifier has insufficient volume to cope with the flow from the main cylinder 10, hydraulic fluid then pumps directly through check valves 22 and 24 and 42 and 40 into the main delivery line at full pressure. At this stage the full load, as shown in FIG. 4 is provided. Check valves 40 and 42 themselves prevent back flow from the hydraulic fluid supply line into the intensifiers.

The system is ideally controlled by monitoring the speed/position of the main

hydraulic cylinder. Starting at with piston 14 stationary both valves 34 and 36, controlling fluid entry into the first and second stages respectively, are open. As the flow from the cylinder 10 increases to a predetermined level the first stage valve 34 will close and subsequently at a higher flow rate the second stage valve 36 will close. The flow rate can be determined by monitoring the velocity of the piston 14. This measurement is applied to a computer control system 46 which controls the opening and closing of valves 34 and 36. Then as the main cylinder slows down the second stage valve 36 will reopen and subsequently at a lower speed the first stage valve 34 will open. By using a the computer control system 46, it is possible to adjust the piston speeds and flow volumes at which the valves 34 and 36 open and close to optimise the power output for the prevailing wave climate. The settings at which the valves 34 and 36 open, on the one hand, and close, on the other, do not necessarily have to be the same.

Ideally the speed of the piston should be monitored directly, but alternatively it could be calculated by the computer by sensing the position of the wave device.

The speed could be also calculated by using a flow meter 44 in the fluid supply 16 to measure the flow of fluid into the cylinder, but this will make the control less predictable as flow and piston cylinder velocity are not directly proportional. In particular, when the first stage valve is open there would be no net fluid flow though supply 16 into the cylinder 10; to overcome this, a controller could be used to open the first stage valve 34 for a set period of time.

FIG. 7 shows another configuration of this invention. In this case there is an additional third stage controlled by an entry valve 48 to a pair of intensifiers 50 coupled to the hydraulic supply 26 line though check valves 52 and 54. This will provide a force velocity profile (FIG. 4) with more steps so it is a better approximation to the ideal shown in FIG. 3. In order for this to work the area ratios of the second and third stage pairs of pressure intensifiers will be different. The second stage intensifier will have the greater intensification. To prevent interaction between the intensifiers an additional two check valves 52 and 54 are required to separate them hydraulically. The method of operation and control is the same as the two stage system shown in FIG. 5.

An alternative arrangement to achieving three stages of intensification is shown in FIG. 8. In this case the additional check valves have been removed and isolation between the two pairs of intensifiers 38 and 50 is achieved by using an additional control valve 56 on the third stage to close flow to both sides of the pair of intensifiers 50. This additional control valve 56 opens and closes at the same time as valve 48. In this method, the third stage valves 48 and 56 are only opened as the second stage valve 36 is closed. This makes change over between second and third stage more complex. This configuration is more difficult to control than that shown in FIG. 7.

The systems described in FIGS. 5, 7 and 8 above require active control. In the marine environment providing such control can sometimes be unreliable and difficult to maintain. The active control systems will provide the best gains in efficiency but these needs to be balanced against increased probability of system failure.

In FIG. 9 a system is shown which requires no electronic computer based control systems or activated valves. Ultimately the system which provides the most economic benefit may be combination of dumb and active control options. The following description of how the system of FIG. 9 works starts just after the piston 14 has just completed a compression stroke in the main cylinder and is about to start moving in the opposite direction into an expansions stroke.

The first stage duct 32 is a rodless piston in a cylinder 58. As the fluid in the annulus 10B of cylinder 10 is expelled, fluid is transferred via the duct 32 and into the right had side of cylinder 58, fluid in the left hand side is passed into the full bore side 10B of cylinder 10, and this continues until the piston in cylinder 58 hits its stop. Then fluid leaving the annulus 10B starts to fill the bore of the right hand of the pair of intensifiers 38 and pumping out higher pressure fluid from its annulus side thorough check valve 40. This continues until right hand cylinder of the pair of intensifiers 38 reaches the end of its stroke and then the third stage intensifiers 50 are actuated in the same way. After the right hand intensifier reaches the end of its stroke the main cylinder 10 then come up to full load, pumping fluid through check valves 24 and 40.

The operation is similar to the systems shown in FIGS. 9 and 11, however instead of using valves to turn each stage on and off the maximum volume displacement of each stage is chosen to provide a limited travel of the main cylinder until the next stage comes in.

As the force 12 is reversed, the piston 14 moves in the opposite direction in a compressions stroke, with the left hand side of cylinder 58 being charged first until its piston reaches its right hand stop, then the left hand intensifier of the pair of intensifiers 38 is charged pumping out high pressure fluid through check valve 42, and finally the same for the pair of intensifiers 50.

FIG. 10 shows a simpler two stage system operating in a similar way to that of FIG. 9, the third stage with the second pair of intensifiers is omitted. With reference to this two stage system, the force, velocity and position profiles are explained below. Assuming simple sinusoidal motion of the main cylinder and constant hydraulic pressure the cylinder force profile will be as shown in FIG. 11.

Increasing position along the horizontal axis in FIG. 11 is equivalent to expansion stroke of the piston in the main cylinder 10; zero position is when the piston 14 is half way through the expansion stroke. Starting at point A, as the main cylinder is initially extended the piston in the first stage cylinder 58 (FIG. 10) moves to the left until it reaches the end of its stroke. The main piston 14 is now at position B.

Then the second stage pair of intensifiers 36 takes over and the main cylinder

pressure difference increases so the cylinder force also increases from B to C. This continues until the piston in the right hand cylinder of the second stage intensifiers 36 reaches the end of its stroke at which time piston 14 at position D.

From then on the main cylinder 10 has to pump all of its flow forward into the main supply line 26 through check valves 24 and 40, so the main cylinder pressure increases and the cylinder force increases from D to E.

If both sides of the main cylinder had equal area (e.g. as with a through rod cylinder) then the reverse profile, when the piston 14 executes a compression stroke would be a mirror image. In FIG. 10, however, a standard cylinder 10 is used where the main bore cross sectional area is greater than that of the annulus, so as the piston moves from position G to H, the piston in the first stage cylinder moves from the left to the right transferring flow from the main bore to the annulus side of the main cylinder 10. However there is an imbalance between the annulus and full bore flows. The excess flow is used in the second stage cylinder/intensifier pair 38 to pump a limited volume of flow forward. So as the cylinder moves from G to H there will be a small negative force on the cylinder.

When the piston moves from I to J the second stage intensifiers 38 will be in operation. As some of its stroke was used in the previous stage the distance I to J will be less than C to D. Additionally the magnitude of force between I to J will be greater than C to D because some flow from the main cylinder 10 will also be pumped forward into the supply line 26 due to the imbalance between bore 10A cross sectional area and annulus 10B cross sectional area.

FIG. 11 assumes sinusoidal motion of the main piston 14, with real waves the forces 12 applied to the main piston 14 will be more random than this. At the end of a wave cycle the main piston 14 is unlikely to be in the same position as it was at the start of the previous wave cycle. The maximum length of AB, CD, GH, and IJ are fixed. For larger waves the length of EF and KL will vary to accommodate different cylinder strokes. For shorter cylinder strokes, the main cylinder 10 may not reach full force EF and KL.

Assuming sinusoidal motion of the main piston 14, FIG. 12 shows the velocity vs. position profile of the main cylinder.

As can be seen from FIG. 12 at the ends of the stroke the main piston 14 velocity is zero and it is a maximum at the mid stroke position. It can also be seen from FIG. 12 the minimum force occurs at minimum velocity and an intermediate force occurs at an intermediate velocity. However the configuration in FIG. 10 will not provide a reducing force as the main cylinder speed decreases. Overall this force profile is not as efficient as those provided by the systems shown in FIGS. 5, 7 and 8. However it will improve the efficiency in comparison to the standard arrangement shown in FIG. 1 and it is simpler to implement than the system shown in FIGS. 5, 7 and 8.

The actual cylinder motion will not be simple sinusoidal. For real systems the main cylinder force will generally increase with increasing speed. Each of the stages shown in FIG. 14 needs to be sized correctly for the actual wave device. If they are oversized then the main cylinder volume displacement may be less than the flow volume required for an intermediate stage, so the force will not increase with increasing speed. Conversely if too small they may increase the force too quickly. This consideration makes designing the system for a variety of wave climates more complex and the designer needs to consider all possible wave climates in choosing the optimal design to gain the best overall efficiency.

The problem of optimising a system of the kind shown in FIGS. 9 and 10 can be reduced by using a semi-automatic system as shown in FIG. 13

In FIG. there are two parallel cylinders 58 and 62 with rod-less pistons. Individual isolation valves 60 and 64 control water entry through ducts 32 and 66 to the left hand sides of the cylinders 58 and 62 respectively. These isolation valves 60 and 64 do not respond to the movement of the main piston but are opened or closed in response to the prevailing wave climate (for example, either by a computer monitoring the wave climate or a system operator) so that the total displacement volume of the first stage cylinders can be adjusted. To give maximum flexibility with this configuration, one of the first stage cylinders would have half the displacement of the other, so that 0, 1/3, 2/3 or 3/3 of maximum displacement can be chosen.

This method of optimization could also be used if second and subsequent stage of pairs of intensifiers were used.

FIG. 14 shows an alternative arrangement of the second and subsequent intensifier stages of FIGS. 9 and 10. The high pressure sides of a pair of second stage intensifiers 38 are coupled to the supply line 26 through check valves 74 and 76 which are in parallel with the check valves 22 and 24, likewise supply of low pressure hydraulic fluid from the supply line 16 comes though check valves 70 and 72 in parallel with the check valves 18 and 20. This arrangement allows slightly smaller check valves to be used. A shown in this arrangement, the first stage of FIGS. 9 and 10 is omitted, although such an omission need not be the case.

In FIG. 15 a further alternative to the first stage cylinder 58 shown in FIGS. 9 and 10. In this case the first stage cylinder 78 has a rod 79, resulting in an annulus side 78B to the cylinder 78 whose cross area is less than the full bore side 78. This arrangement can be used to accommodate for differences in areas on the annulus 10B and full bore side 10A of the main cylinder 10.

Throughout the examples a single double headed piston 14 in a main cylinder 10 is illustrated. It is more usual to use two or more of such pistons in individual cylinders mechanically joined to the same supply of wave energy. In such a case the outputs for the main bores 10A of the two cylinders would be connected to each of the stages shown in the figures and would the outlet of each of the annuluses 10B. The description in refereeing to the main cylinder 10 and main piston 14 should be taken as referring to both main cylinder and both main pistons.

Although piston operated hydraulic intensifiers are specifically described herein, any form of hydraulic intensifier may be used where piston operated intensifiers are described. One new such intensifier, allowing for steady pressure build, on the double acting piston arrangement in a way that is closer to the ideal of FIG. 3 than the stepped approach of FIG. 4 is illustrated in FIGS. 16 to 18.

In FIG. 16 a hydraulic motor 108, which is a component part of variable hydraulic intensifier 107 is driven from the outputs of a double acting piston arrangement, comprising a cylinder 100, whose double headed piston 104 is driven by a through rod 103 is driven in either direction according to the direction of the wave loading 12. A variable hydraulic intensifier 107 comprised a hydraulic motor whose drive shaft drive is connected to a variable displacement over centre pump 109. The double headed 104 pumps on either side of its head according to its direction of movement, driving hydraulic fluid to and fro though a duct 106 from one side of the cylinder to the other, through the hydraulic motor 108. Hydraulic motor 108 drives a variable displacement over centre pump 109 which can pump in in one direction only even when the hydraulic motor 108 changes direction as a result of reversal of flow through duct 108. The output of pump 109 is supplied to the supply duct 26 of main hydraulic motor 28. The input of pump 109 comes from tank 15 though supply duct 16; tank 15 may also feed other motors of other similar intensifiers in a wave system through ducts 17. When the variable over centre pump 109 has zero displacement, the load on the double acting piston 104 will be at a minimum. As the variable displacement of the pump 109 increases so will the load on cylinder 100. It will be noted that in this arrangement the cylinder 100 does not need a regular supply of top up hydraulic once enough has been provided to charge cylinder 100 and duct 106, thus greatly simplifying the valve arrangements required.

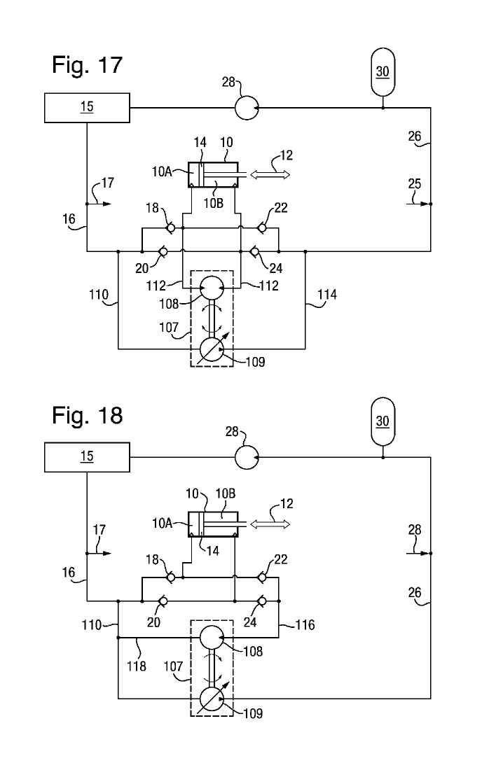

In FIG. 17, a variable hydraulic intensifier 107 again comprises a hydraulic motor

108 whose output shaft can drives a variable over centre pump 109. In this case the arrangement includes a main cylinder 10 with a double acting piston 14, but with a main bore 10A and an annulus 10B, the piston rod being on the annulus side 10B of the piston 14, as in FIG. 1. Because of the unequal volumes of the main bore 10B and annulus 10B, there will be some pumping from the main bore side directly though valve 24 into the main motor supply line at the end of the compression stroke, the main bore 10A will also need replenishment towards the end of its expansion stroke from tank 15 though valve 18. Otherwise the mode of operation is similar to that described in FIG. 16, with the motor 108 connected to the main bore 10A and annulus 10B by duct 112, which will experience to and fro flow as the main more 10A and annulus 10B pump in turn, The input of pump 109 comes from tank 15 though supply ducts 16 and 110; tank 15 may also feed other motors of other similar intensifiers in a wave system through ducts 17. The output of pump 109 is fed directly to the main supply duct 26 though duct 114, with no valve control. When the variable over centre pump

109 has zero displacement, the load on the double headed piston 14 will be at a minimum. As the variable displacement of the pump 109 increases so will the load on double headed piston 104, bringing that pressure eventually to the pressure in line 26. Although this arrangement does not entirely dispense with the need for control valves, the number is reduced compared with the arrangements of FIGS. 9, 10 and 13.

In FIG. 18 a further alternative arrangement to that in FIG. 16 is shown but still using a variable hydraulic intensifier 107 comprising a hydraulic motor 108 whose output shaft can drives a variable over centre pump 109. The cylinder 10 with a wave load input 12 to a double headed piston 14 has input and output control valves 18, 20, 22, and 24 as shown on FIG. 1. However, in this case the output, which passes alternately through control valves 22 and 24, is taken though a duct 116 to the hydraulic motor 108 which drives the variable displacement of pump 109 as before. However, hydraulic fluid passes through motor 108 in one direction only and leaves through duct 118 to join the supply duct 110 of the variable displacement pump 109, and is pumped through pump 109 (together with additional supply directly though duct 16) directly into the supply line 26 to hydraulic motor 28.

In each of the three examples in FIGS. 16 to 18, supplies to and from other double acting piston arrangements in the wave farm are shown by lines 17 and 25 respectively, and one or more accumulators 30 can be deployed as before.

FIG. 19 is identical to FIG. 10, save that the double headed piston 14 in a single cylinder 10, shown in FIG. 10, is replaced by two displacement cylinders 120 and 122 acting cooperatively and in tandem. Where power 12 from a wave motion in one direction is fed to the piston of a first cylinder 120, it causes that cylinder to execute a compression stroke to pump hydraulic fluid from the cylinder. At the same time the second cylinder 122 expands drawing in hydraulic fluid from the supply line 16. When wave loading moves in the opposite direction the second cylinder 122 undergoes a compression stroke and pumps the hydraulic fluid originally drawn in, at the same time the first cylinder 120 expands drawing in further hydraulic fluid from the supply line 16. The two cylinders have a mechanical linkage so that one expands as the other contract and vice versa. The outputs of cylinders 120 and 122 are passed through two stages of intensification exactly as discussed with respect to FIG. 10 and the other illustrated components in FIG. 19 perform the same functions as they did in FIG. 10.

In FIG. 20 the mechanical linkage mentioned in FIG. 19 is taken one stage further, with the rods 124 and 126 of the pistons of figures 120 and 122 being directly connected, in one further possibility the rods 124 and 126 are replaced by one common rod.

Usually two or more double acting piston arrangements acting in tandem from a common input are used with systems of the kind described in this invention. The outputs of the piston arrangements are joined. In the figures therefore, cylinders 10, 100, 120 and 122 should be seen as representing one, two or more such cylinders working in tandem whose output are joined.

1. A wave power capture system comprising a hydraulic motor, a hydraulic supply duct to the hydraulic motor, a source of hydraulic fluid, a double acting piston or two opposed pistons and an output from each side of the double acting piston arrangement or each of the opposed pistons coupled to and driven from a reciprocating source of wave energy, either side of the double acting piston or each pair a pair of opposed pistons having a connection connected to the source of hydraulic fluid reciprocation of the source of wave energy pumpings hydraulic fluid alternately from each output of the double acting piston or opposed pistons to the duct and wherein the flow from and differential pressure of the double acting piston or opposed pistons may be different to the flow and differential pressure in the hydraulic supply duct and that such difference is variable.

2. A wave power capture system according to claim 1 wherein the hydraulic fluid from the double acting piston or pair of opposed pistons may be supplied to the hydraulic supply at a reduced rate while the output flow rate of the double acting piston or opposed pistons is below a predetermined minimum.

3. A wave power capture system according to claim 1 wherein the outputs of the double acting piston or pair of opposed pistons have a direct hydraulic connection by-passing the hydraulic motor controlled by a stop valve which is open until the output flow rate of the double acting piston or pair of opposed pistons exceeds the predetermined minimum.

4. A wave power capture system according to claim 1 further comprising a double headed piston in a cylinder with one end of the cylinder hydraulically connected to one output of the double acting piston or one of the pair of opposed pistons and the other end the cylinder to the other output of the double headed piston or other of the pair of opposed pistons.

5. A wave power capture system according to claim 1 further comprising a first pair of hydraulic intensifiers, the low pressure side of the pairs of hydraulic intensifiers being connected hydraulically to one output the double acting piston and or the output of one of the pair of opposed pistons, the low pressure side of the other of said pair of hydraulic intensifiers connected hydraulically to the other output of the double acting piston or the output of one of the other of the pair of opposed pistons and the high pressure side of each hydraulic intensifier is connected via a non-return valve to the hydraulic duct to the hydraulic motor.

6. A wave power capture system according to claim 5 in which the pair of hydraulic intensifiers comprise piston operated intensifiers wherein the intensifiers are connected together to that they drive one another and wherein one charges from its low pressure input and supplies a higher pressure output, while the other returns to an uncharged position.

7. A wave power capture system according to claim 6 in which the pistons of the intensifiers are joined by a common rod.

8. A wave power capture system according to claim 5 comprising one or more further hydraulic intensifiers each connected to the double acting piston arrangement in a similar way to the first pair of hydraulic intensifiers.

9. A wave power capture system capture system according to claim 8 in which the flow rates from the pairs of hydraulic intensifiers increases in steps from a first pair to a final pair.

10. A wave power capture system according to claim 9 in which the pairs of hydraulic intensifiers respond in turn to increasing flow rates from the double acting piston arrangement.

11. A wave power capture system according to claim 9 further comprising valves regulating entry of hydraulic fluid to the low pressure side of each of the pairs of hydraulic intensifiers said valves opening and closing on the basis of the output flow rate from the double acting piston arrangement.

12. A wave power capture system according to claim 1 further comprising a variable hydraulic intensifier coupled to the outputs of the double acting piston arrangement which a variable hydraulic intensifier may pump hydraulic fluid to the said hydraulic supply duct to the hydraulic motor.

13. A wave power capture system according to claim 12 in which the variable hydraulic intensifier comprises a hydraulic motor driving a variable displacement over centre pump, said variable displacement over centre pump connected to the said hydraulic supply duct to the hydraulic motor.

14. A wave power capture system according to claim 13 in which the hydraulic motor of the intensifier is connected in a further duct between the outputs of the -a-double acting piston or the outputs of the opposed pistons wherein to and fro movement of hydraulic fluid in said further duct drives the motor and in turn a variable displacement over centre pump.

15. A wave power capture system according to claim 12 further comprising one way valves between the outputs of the double acting piston arrangement and one side of the motor of the variable pressure intensifier and a variable displacement over centre pump receiving the output of the variable pressure intensifies the output of variable pressure intensifier being connected to the said hydraulic supply duct to the hydraulic motor.

16. A wave power capture system according to claim 1 in which the double acting piston comprises a double headed -piston head reciprocating in a single cylinder and single piston rod on one side of the piston head.

17. A wave power capture system according to claim 16 further comprising compensation for any difference in the chamber area either side of the double acting piston.

18. A wave power capture system according to any preceding claim 1 in which the double acting piston arrangement comprises a double headed piston head reciprocating in a single cylinder and in which the cylinder has a through rod.

19. (canceled)

20. A wave power capture system according to claim 1 in which the opposed pistons comprise displacement pumps with their rods joined.

21. A wave power capture system according to claim 20 in which the opposed pistons comprise displacement pumps having a common rod.

22-32. (canceled)
